(19) United States
(12) Patent Application Publication
(10) Pub. No.: US 2010/0220886 A1
(43) Pub. Date: Sep. 2, 2010

(54) EAR-ATTACHMENT DEVICE AND METHOD

(76) Inventor: Joseph GRUNDY, Chatswood (AU)

Correspondence Address: STITES & HARBISON PLLC, 1199 NORTH FAIRFAX STREET, SUITE 900, ALEXANDRIA, VA, 22314, US

(21) Appl. No.: 12/394,778

(22) Filed: Feb. 27, 2009

(51) Int. Cl. H04R 25/00

(52) U.S. Cl. 381/381

(57) ABSTRACT

An ear-attachment device attaches an electronic hearing-related device to an ear. The device uses concha-gripping-means to grip at least part of a concha of an ear therebetween. An electronic hearing-related device is attached to the concha-gripping-means.

### FIELD OF INVENTION

The present invention relates to devices for attaching an electronic hearing-related device to an ear, and a method of attaching such devices to an ear.

### BACKGROUND OF THE INVENTION

Many types of electronic hearing-related devices need to be attached to an ear so that the device can be held proximate to the ear to enhance or facilitate hearing, as the case may be.

Such hearing-related electronic devices can include ear phones, typically used with portable MP3 players, hearing aids, and devices that interact with other hearing-related components that have been implanted inside the user. Hearing-related electronics are also used in industrial applications, such as ear-mounted intercom systems.

These hearing-related electronic devices are held onto the ear using a variety of known devices, each having drawbacks and disadvantages. For example, the known devices have a greater tendency to being dislodged if the device or cables are jostled, or if the wearer jerks or shakes his head. Such known attachment devices have a higher degree of vulnerability to falling off when the user is running.

Some known devices rely on gravity to hold a device wrapped around the portion where the ear meets the head, and/or friction with some part of the ear, in order to resist the tendency of a device being pulled away or out of some part of the ear, however, such devices are still prone to dislodgement when the user runs or otherwise moves energetically particularly with violent motion.

Some known attachment devices are shaped so as to be inserted into the ear canal. These devices can have a greater tendency to fall out of the ear particularly when the user moves suddenly, such as when jerking or shaking his head. In addition to discomfort, a problem with these ear-insertion devices is that the devices are more suited for supporting light-weight, small hearing-related device that can actually fit in the ear canal, and are thus not as adept for supporting larger hearing-related device that cannot fit in the ear canal.

Other known attachment devices are in the form of ear-buds, designed to rest in the ear-fold proximate the entrance to the ear canal. These are typically seen in the ear-bud earphones that are supplied with electronic MP3 players. These have a greater tendency to fall off the ear, since the ear-bud device merely rests in the lower fold of the concha 10 near the tragus 20, as shown in background FIG. 1. Also, these ear-bud devices are generally more suited for attaching smaller, lighter-weight devices to the ear. These ear-bud devices are also usually designed to fit a notional average ear-shape, and thus as less suited to non-average ear-shapes.

Other known attachment devices include a generally C-shaped hook device that hooks around and rests on the valley 18 of the ear, and, moreover, relies on gravity for the hook device to remain seated on that part of the ear.

In some of these C-shaped hook devices, the electronic hearing-related device is positioned or attached to an end of one of the arms of the C-shape hook such that, when the hook is placed over the ear, the hearing-related device is positioned in front of or in the ear canal. In either case, generally, such C-shaped hook devices are nevertheless more prone to falling off or dislodging, particularly when the person engages in high intensity activity.

Other known attachment devices include a portion that is custom-moulded to suit the exact contour's of a particular user's concha area that is proximate the entrance of the ear canal, however, the personalised degree of customisation means that such devices are expensive and complex to produce.

An object of the present invention is to overcome or at least ameliorate one or more of the problems in the prior art, or to provide an improved alternative.

### SUMMARY OF INVENTION

According to a first aspect of the present invention, there is provided an ear-attachment device for attaching an electronic hearing-related device to an ear, comprising:

concha-gripping-means which is adapted to grip at least part of a concha of an ear therebetween, in use, and to which concha-gripping-means an electronic hearing-related device is attached or attachable.

Preferably, the concha-gripping-means includes:

front-concha-grip-means; and

rear-concha-grip-means,

wherein, in use, the concha-gripping-means is able to grip the concha therebetween with the front-concha-grip-means pressed against at least part of the front of the concha, and with the rear-concha-grip-means pressed against at least part of the other side of the ear that is behind the concha.

The front-concha-grip-means may be adapted, in use, to apply pressure to the surface inside a curved crevice in the upper front portion of the concha.

Preferably, the concha-gripping-means has biasing-means that urges the front-concha-grip-means and the rear-concha-grip-means towards one another.

Preferably, the biasing-means is able to press both sides of the concha so as to hold the concha-gripping-means securely to the concha gripped therebetween.

The biasing-means may include one or more magnetic components provided in each of the front-concha-grip-means and the rear-concha-grip-means which are mutually attractive to each other so as to bias one towards the other.

The front-concha-grip-means and the rear-concha-grip-means may be both separable components.

Alternatively, the front-concha-grip-means and the rear-concha-grip-means may comprise a single component.

Preferably, the front-concha-grip-means curls back towards the rear-concha-grip-means to form a clamping mechanism therebetween.

In a preferred embodiment, the front-concha-grip-means, in use, wraps generally around the valley of the ear and curls back across the front of the ear towards the rear-concha-grip-means.

In another preferred embodiment, the front-concha-grip-means, in use, curls around the lateral, front side of the ear and then curls around back towards the rear-concha-grip-means.

In a further preferred embodiment, the front-concha-grip-means, in use, curls underneath the ear and curls around back towards the rear-concha-grip-means.

The electronic hearing-related device may be capable of emitting sound hearable by the ear.

The electronic hearing-related device may include a sound wave receiver and/or a sound wave generator.

The electronic hearing-related device may be able to communicate with a hearing-related implant in the user.

The electronic hearing-related device may include a hearing-aid.

The electronic hearing-related device may include an ear phone speaker.

According to a second aspect of the invention, there is provided a method of attaching an electronic hearing-related device to an ear, comprising the step of:

attaching an electronic hearing-related device to concha-gripping-means of an ear-attachment device; and

using the concha-gripping-means to grip therebetween at least part of a concha of an ear so as to secure the ear-attachment device to the ear.

Preferably, the concha-gripping-means includes:

front-concha-grip-means; and

rear-concha-grip-means,

and wherein the method includes the steps of:

pressing the front-concha-grip-means against at least part of the front of the concha; and

pressing the rear-concha-grip-means against at least part of the other side of the ear that is behind the concha such that the concha-gripping-means grips the concha therebetween.

In an exemplary embodiment, the concha-gripping-means may have biasing-means that urges the front-concha-grip-means and the rear-concha-grip-means towards one another,

and wherein the biasing-means may press both sides of the concha so as to hold the concha-gripping-means securely to the concha gripped therebetween,

and wherein the biasing-means may include one or more magnetic components provided in each of the front-concha-grip-means and the rear-concha-grip-means which are mutually attractive to each other so as to bias one towards the other.

### DRAWINGS

In order that the present invention might be more fully understood, embodiments of the invention will be described, by way of example only, with reference to the accompanying drawings, in which:

FIG. 1 is a diagram of a typical human ear, and is provided by way of background information;

FIG. 2 shows the location of part of the concha where an embodiment of the invention can be clamped;

FIG. 3 is a side view of a first embodiment of an ear-attachment device;

FIG. 4 shows the embodiment of FIG. 3 attached to an ear by gripping the concha between parts of the device;

FIG. 5 shows a side view of the clamping arm of the embodiment of FIGS. 3 and 4;

FIG. 6 shows an end view of the clamping arm of FIG. 5 seen from a first perspective;

FIG. 7 shows another end view of the clamping arm of FIG. 5 seen from another perspective that is perpendicular to the perspective used for FIG. 6;

FIG. 8 shows a perspective view of a second embodiment of an ear-attachment device;

FIG. 9 shows a perspective view of a third embodiment of an ear-attachment device;

FIGS. 10A and 10B show perspective views of a fourth embodiment of an ear-attachment device;

FIGS. 11A and 11B show perspective views of a fifth embodiment of an ear-attachment device; and

FIGS. 12A and 12B show perspective views of a sixth embodiment of an ear-attachment device which makes use of magnets; and

FIG. 13 is a schematic view of a user's head.

In the embodiments, like components are labeled with like reference numerals merely for the sake of ease of understanding the different embodiments and modifications.

### DESCRIPTION OF EMBODIMENTS

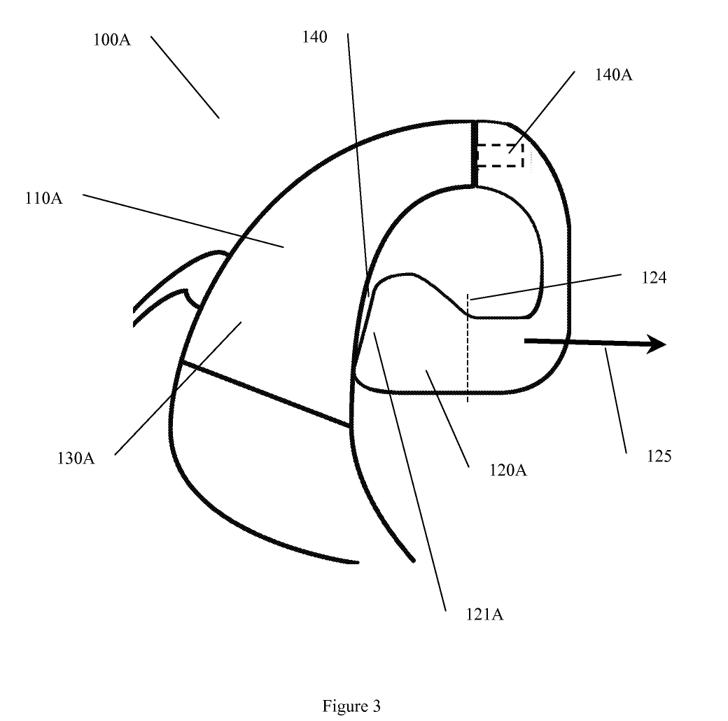

Referring to the accompanying drawings, FIG. 3 shows an embodiment of an ear-attachment device for attaching an electronic hearing-related device to an ear. The first embodiment is in the form of an earpiece-processor device 100A.

The earpiece-processor device 100A of FIG. 3 carries an electronic hearing-related device in the form of a sound processor 110A which, in this example, is an external component that is able to electronically interact with a bionic hearing device which has been surgically implanted in the user's head for improvement of hearing.

In the present embodiment, the sound processor 110A is integrally attached to the portions of the device 100 that are responsible for clamping. In other words, the sound processor 110A forms part of the overall earpiece-processor device 100.

In other modifications, the electronic hearing-related device is able to be attached in a manner that allows it to be removed, and even replaced.

In the embodiment, the main feature of the earpiece-processor device 100A is its ability to attach to the ear at the location of the concha, and specifically, the earpiece-processor device 100A is able to grip the concha therebetween from both sides of the ear.

The word “therebetween” refers to the fact that the gripping action is accomplished by gripping from both sides of the ear, rather than from merely one side only. Therefore, this invention excludes from its scope any devices which attach to the ear only from one side, or which are not able to actually grip the concha.

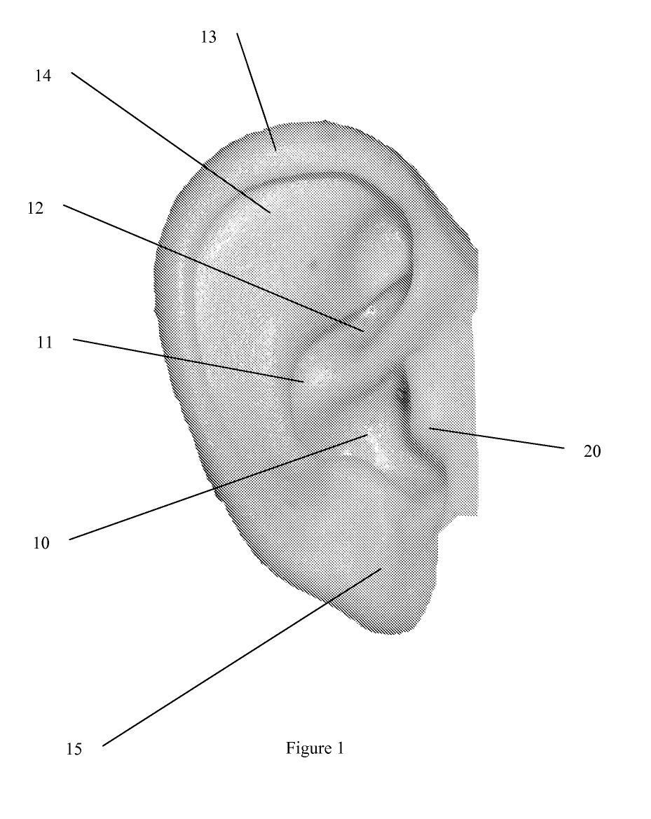

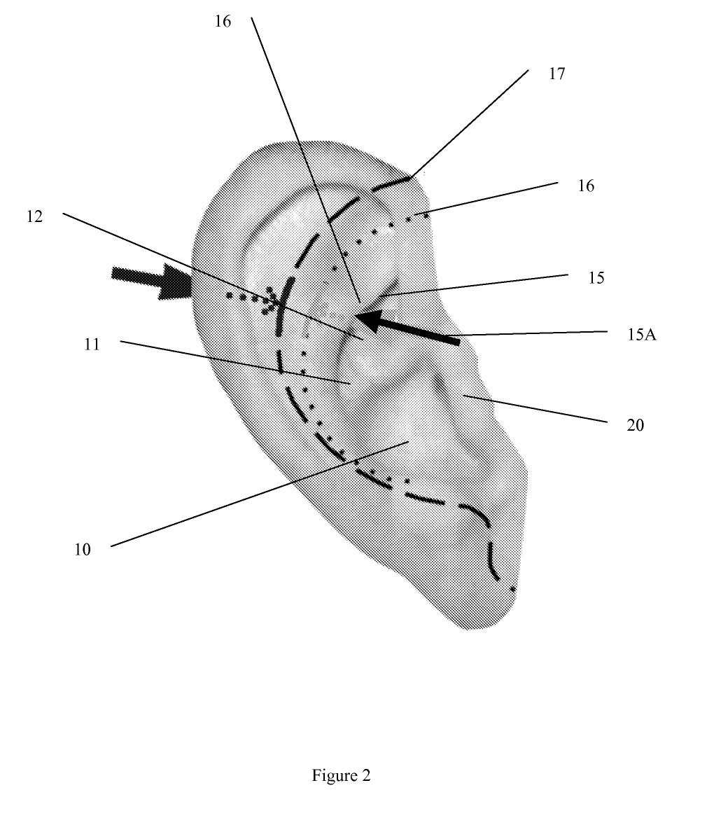

FIGS. 1 and 2 show an illustration of a human ear in which the concha 10, 11, 12 of the ear is a hollow region that is next to the ear canal.

FIG. 2 indicates the location of a crevice 15 in the upper part of the concha 12. The arrow 15A points into this crevice in the concha. The curvature of the inner surface of the hidden crevice 15 is indicated in FIG. 2 by a dotted line 16.

### Concha Attachment

A premise of the present invention is that the concha 10, 11, 12 is an ideal location for a bi-directional gripping device to grip the ear.

In contrast, other parts of the ear are regarded as less ideal for gripping, according to the present invention. Compared to the concha, the other parts of the ear, for example, the helix 13, scapha 14, and lobule 15, are all softer, more flexible or supple, thus less capable of providing a stable basis for attaching a device by gripping. These other ear parts are also more inclined to experience discomfort when compressed or gripped for longer periods of time, compared to the concha. Furthermore, these other parts of the ear tend to be more variably proportioned from one person to another, as compared to the concha.

In contrast to all the other non-ideal areas of the ear, the concha 10, 11, 12 presents an ideal location to grip the ear from both sides because the concha is relatively rigid compared to other parts of the ear, hence, it has sufficient rigidity to support larger electronic devices.

The concha also has relatively little feeling and is relatively insensitive compared to other parts of the ear. For instance, if continuous pressure were to be applied to other parts of the ear, especially the helix 13 and, for some people, the lobule 15, those parts can soon become sore or painful to the user. In contrast, the concha 10, 11, 12 can be pinched from both sides for a considerable length of time without most users experiencing any degree of discomfort.

In comparison to other parts of the ear, such as the helix 13, scapha 14 and lobule 15, the portion of the ear at the concha is relatively harder or, as it were, stiffer than those parts of the ear that are closer to the edge margins of the ear which tend to be more supple. Hence, the stiffer concha is a more suitable place to pinch or grip the ear from both sides. It is more suitable because the stiffness of the concha provides a more stable support for attachment of devices thereto. Also, it means that heavier devices can be attached to the concha, compared to other less stable parts of the ear.

Moreover, the concha is spread across a relatively large region of the ear, i.e. the curve of the concha, around the ear canal entrance, is gradual. The concha extends all the way from near the top of the ear, close to where the helix 13 joins the head 19, all the way to near the bottom of the ear, close to where the lobule 15 joins the head 19. This relatively large area of the concha has implications for manufacturing devices, intended to grip the concha, because it means that, potentially, a one-size-fits-all device may be produced that has a high likelihood of engaging the concha of a wide range of people. This is because, even though the ear shapes of people vary widely, the large area of the concha means that a standard, non-custom-designed device will have a greater likelihood of fitting into the concha of a wider range of people.

### Gripping the Concha

In FIG. 3, the earpiece-processor device 100A is provided with concha-gripping-means in the form of a clamping mechanism, described in more detail further below.

In the embodiment, it is important that the earpiece-processor device 100A grips the concha 10, 11, 12 from both sides of the ear, in other words, that the concha is generally in between the gripping portions of the earpiece-processor device 100A. The fact that the concha 10, 11, 12 is gripped between the gripping portions means that the earpiece-processor device 100A is less likely to fall off the ear, or to be jolted off the ear through sudden, violent motion of the person.

It is noted that, admittedly, any ear-mounted device is removable, in the sense that it can be removed from the ear. This means that any ear-mounted device, in one way or another, can possibly fall off or be knocked off the user's ear. Hence, there is no claim made here that embodiments of the invention cannot fall off or be knocked off the user's hear, however, it is observed that embodiments of the present invention appear to be less vulnerable to being knocked off or falling off the ear, as compared to known devices.

The invention, in its broadest aspect, does not cover devices where there is no portion of the concha able to be gripped between bi-directional gripping parts of the ear-attachment device, i.e. acting from two directions. A premise of the present invention is that the benefits of gripping the concha from both sides cannot readily be replicated by attachment to other parts of ear.

### Concha-Gripping-Means: Biasing

In FIG. 3, the clamping mechanism of the earpiece-processor device 100A includes:

front-concha-grip-means in the form of a front clamping arm 120A; and

rear-concha-grip-means in the form of the main body 130A of the device 110AA. The electronic processor 110A (the hearing-related device) is contained within the main body 130A.

Hence, in the specification, the words “attached” or “attachable” should be given a broad interpretation, and not restricted to a particular manner of attachment of the electronic hearing-related device to the concha-gripping-means. The end result of the attachment or attachability is that the electronic hearing-related device is or becomes part of an overall assembly that has the concha-gripping-means, which enables the electronic hearing-related device to be attached to an ear.

The electronic hearing-related device may be located in the front-concha-grip-means and/or in the rear-concha-grip-means. Alternatively, the electronic hearing-related device can be on the relevant component.

In the embodiment, the front clamping arm 120A and the main body 130A are connectable one to another to form a single component, namely the earpiece-processor device 100A.

In the embodiment of FIGS. 3 and 4, an end portion of the main body 130A has a support post 140A. The front clamping arm 120A is supported on this post 140A. (In FIGS. 3 and 4, the support post 140 is shown in dotted lines since, in use in practice, the post 140A is embedded within the front clamping arm 120A.)

The clamping mechanism of the device 100A has biasing-means that urges the front-concha-grip-means and the rear-concha-grip-means towards one another to achieve a clamping action.

In the embodiment of FIGS. 3 and 4, the biasing-means is provided in the form of characteristics of the material from which the front clamping arm 120A is made. In the embodiment, the clamping arm 120A is made from a resilient, springy material that, when flexed, tends to restore itself to its original orientation. Thus, in the embodiment, when the clamping arm 120A is flexed and pulled away from the main body 130A (as shown by arrow 125), the tendency is for the resilient-biasing of the material to cause the clamping arm 120A to pull back towards the main body, as shown by arrow 126.

Thus, in use, when a portion of the concha is located in the space 140 between the clamping arm 120A and the main body 130A, it is the resilient-biasing of the material of the clamping arm 120A that causes the concha tissue to be compressed between the two clamping components.

In other modifications and embodiments, the biasing-means can be created or enhanced by a mechanical biasing mechanism, such as a spring-loaded mechanism that urges the two component towards each other.

FIG. 3 shows the device 100A when it is not in use, and not attached to an ear. This diagram particularly shows that, when not in use, the front clamping arm 120A is pressed substantially up against the surface of the main body 130A. In the embodiment, when the device is not being used on the ear, there is hardly any gap in the space 140 between the surface of the front clamping arm 120A and the surface of the main body 130A.

In embodiments, it is important that whatever gap 140 that there is between the clamping components, such a gap, if any, has to be very significantly smaller than the thickness of a typical concha, otherwise it would be difficult to achieve a clamping action with the concha therebetween.

The point is that, when the device 100A is attached to the ear, part of the flat tissue of the concha 10, 11, 12 will be situated in this position in between the surface of the front clamping arm 120A and the surface of the main body 130A.

In use, the concha is gripped between with the distal end 121A of the front clamping arm 120A, which presses against at least part of the front of the concha, and the main body 130A, which presses against at least part of the other side of the ear that is behind the concha. In other words, the concha is gripped from both sides.

Thus, in use, the resilient-biasing-means is able to press both sides of the concha so as to hold the clamping mechanism of the device 100A securely to the concha gripped therebetween.

In a sense, the clamping action of the front clamping arm 120A and the main body 130A, which are urged towards each other by the resilience of the material, resemble a pincer-like gripping action. The gripping occurs by two components, being urged together from opposite directions, to sandwich the tissue of the concha between the components.

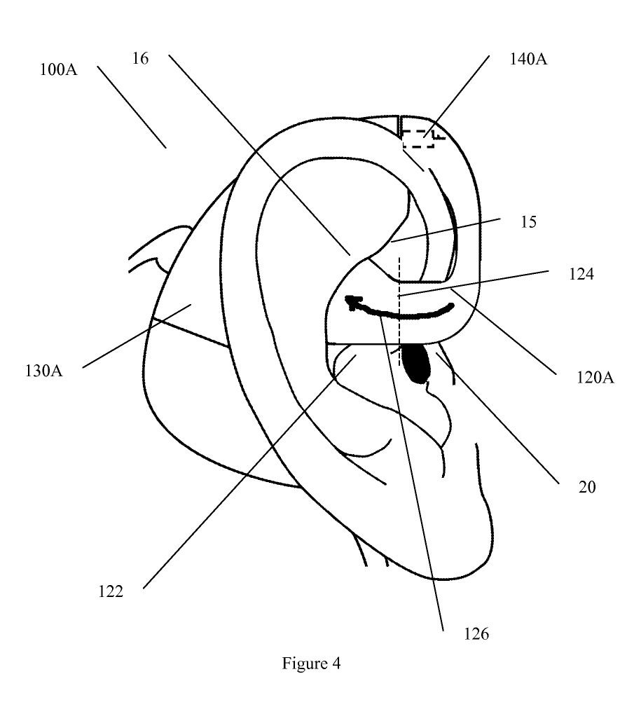

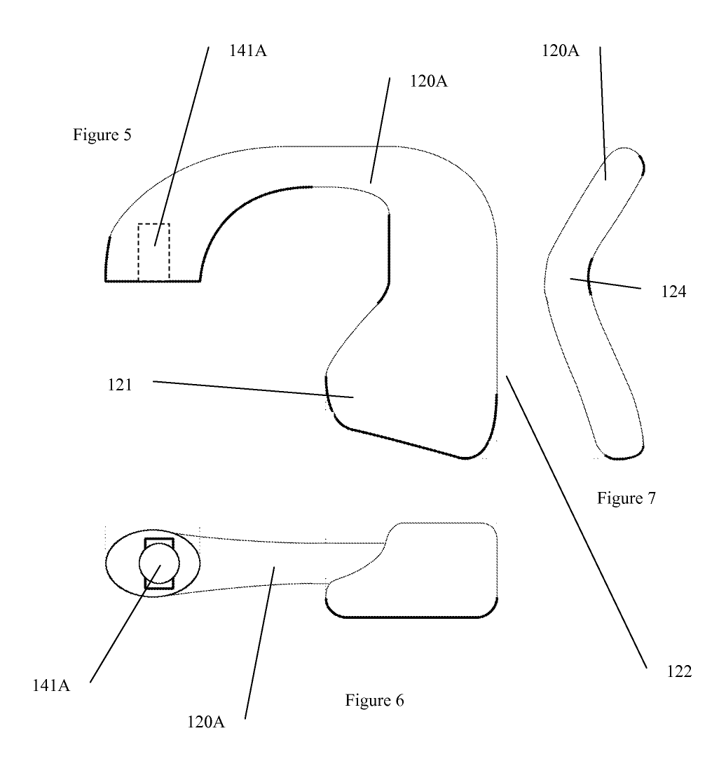

FIG. 5 shows a side view of the clamping arm 120A. In the embodiment of FIGS. 3 and 4, the front clamping arm 120A is a separate component from the main body 130A, and the two are subsequently joined together. An end of the clamping arm is provided with a hole 141A into which the support post 140A is able to be inserted. In various embodiments, the manner of connecting the components 120A, 130A may be varied with suitable connection mechanisms. Preferably, the connection should disallow rotation about the post 140A. In FIG. 3, the front clamping arm 120A is able to be removed from the support post 140A for replacement or repair of the arm 120A.

In other variations, the front clamping arm 120A and the main body 130A may be manufactured to be a single, seamless piece of material.

FIG. 6 shows a side, end view of the clamping arm 120A of FIG. 5.

FIG. 7 is another side, end view of the clamping arm of FIG. 5, which indicates that the arm 120A has a kink 124. In FIGS. 3 and 4, the kink 124 is indicated with a dotted line. In FIG. 4, when the device is on the ear, the angular kink 124 points outwardly and away from the user's head. The tragus 20 of the ear usually protrudes slightly away from the head, hence, the kink 124 enables the clamping arm 120A to straddle over the tragus 20. This kink can therefore minimise the amount of contact between the tragus 20 and the clamping arm 120A. This is an advantage since the tragus 20 can sometimes tend to be susceptible to soreness as a result of prolonged rubbing or contact.

In the embodiment, if there were no kink in the clamping arm 120A, the protruding tragus 20 may tend to push the clamping arm 120A outwardly, thus imparting a pivoting force that would act to push the clamping arm 120A away from the user's head. Thus, the presence of the kink 124 also allows the clamping arm 120A to nestle against the side of the user's head.

### Concha Gripping Location

In embodiments of the invention, the front-concha-grip-means can press anywhere on the concha. Moreover, in practice, the exact location that the front-concha-grip-means presses on the concha will almost certainly vary from person to person, given that the conchas of different people vary in shape.

For example, in FIG. 4, if the device 100A were to be used by a person with a larger ear, it is likely that the clamping arm 120A would press on a part of the user's concha that would be towards the upper regions of the concha.

In comparison, if the device 100A were used on a smaller ear, the clamping arm 120A would most likely press on a part of the concha that would be towards the lower regions of the concha.

Even though the embodiments can press on various parts of the concha, depending on the size of the actual user's concha, it is observed that clamping the device 100A to any part of the concha would most likely provide superior attachment to the ear compared to the above-described prior art.

Since the benefit of the embodiment can be achieved, even when different parts of the concha are gripped, it means that, in practice, it may suffice to produce a small range of models for sale on the market. Therefore, an advantage is that, for example, one or two models of embodiments are likely to cater for a very wide range of the market ranging from infants to adults, without the need for creating customised or personally-shaped models for a range of individuals. This is because the concha occupies a relatively large area of the ear, hence, it acts as a wide target that can be easily located when the device is attached. Thus, embodiments of the invention, which engage with the front and rear of the concha, are able to be used by a wide segment of the population in which their concha shapes can vary widely.

In the example of FIG. 4, given the size of the ear in the illustrated example, the front-concha-grip-means, in this instance, presses on part of the concha that is inside a curved crevice 15 in the upper front portion of the concha. FIG. 4 shows the front clamping arm 120A of the device 100A pressed into this curved crevice 15 of the upper part of the concha. In this example, in use, the wall 16 of the crevice 15 acts as a ramp that the front clamping arm 120A must surmount if it is to pull away from the ear. Thus, for the embodiment of FIGS. 3 to 7, when used on ears of a particular size, the wall 16 of the crevice 15 enhances the ability of the device 100A to remain in place on the ear, even when the person moves with violent motion, such as when running.

It is emphasized, however, that the invention, in its broadest aspect is not limited to pressing the concha at this location in the crevice 15, as shown in FIG. 4, since an advantage of the embodiments is that the benefits of concha-clamping can be achieved by pressing at any location on the concha.

### Variations in Gripping the Concha

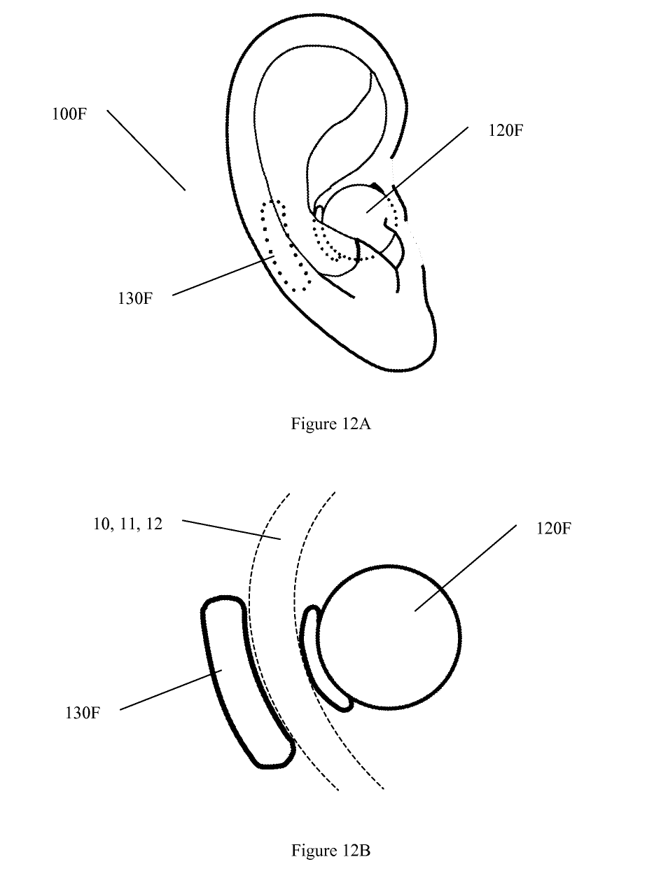

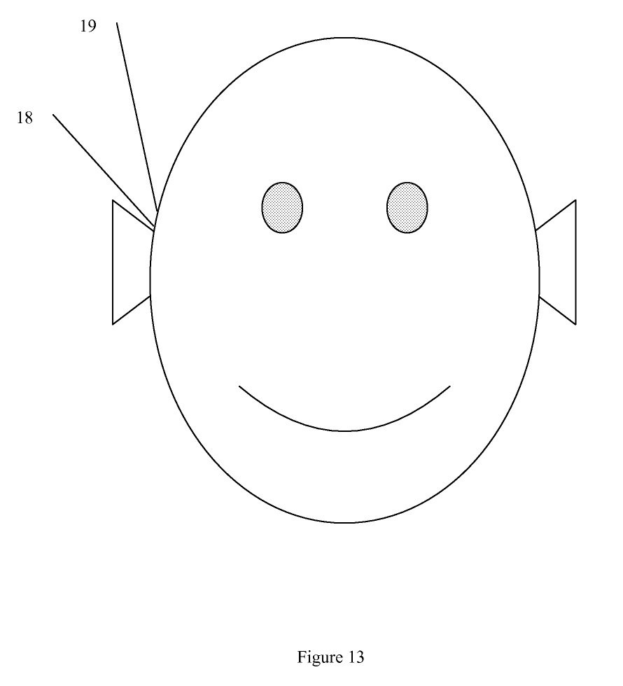

In this specification, the narrowed portion of the ear that adjoins the head 19 will be referred to as a valley 18, illustrated schematically in FIG. 12.

In the first embodiment of FIG. 3, the front clamping arm 120A curls back towards the main body 130A to form a clamping mechanism therebetween. In FIG. 4, in use, the main body 130A generally wraps from behind the ear upwards and around the valley 18, to a point where the main body 130A meets the front clamping arm 120A. From there, the front clamping arm 120A extends from the valley 18 slightly forwardly and then curls generally downwardly for a portion, and then gradually curls across the front of the ear and back to the main body 130A, until it eventually presses against the concha, as shown in FIG. 4. Thereby, the concha is compressed between the main body 130A and the front clamping arm 120A.

The word “curl” does not restrict the embodiment to having a curved configuration. For example, in another modification, a curled clamping arm may comprise a C-shaped component having orthogonal limbs, each being perpendicular to the next closest limb. In such a modification, it would also be considered that the square C-shaped component would “curl” around.

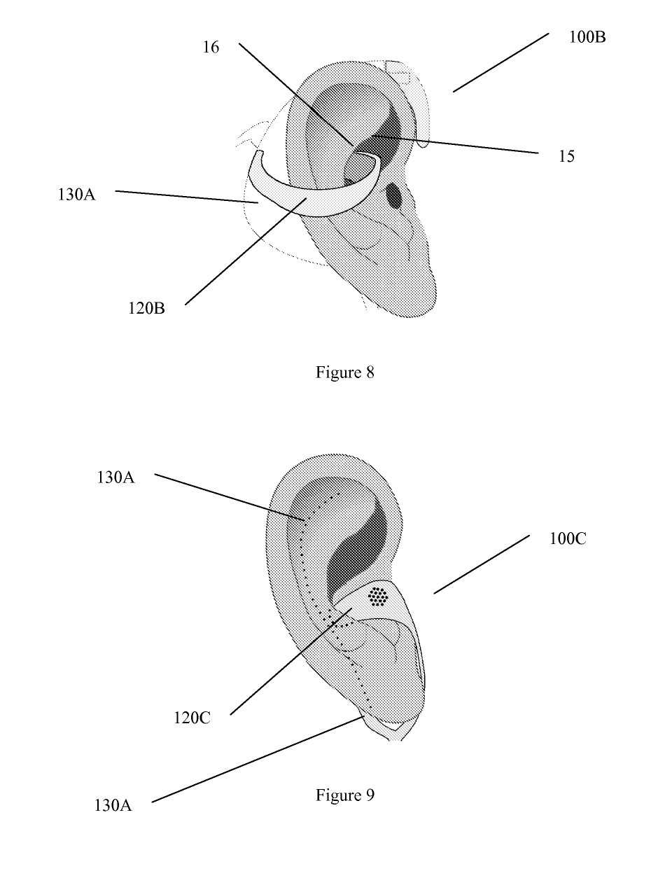

FIG. 8 shows a modified second embodiment which is an earpiece device 100B. The front clamping arm 120B starts from behind the ear, projects outwardly from the main body 130A, and then curls forwardly around the lateral, front side of the ear, and then curls back in towards the main body 130B to form a clamping mechanism therebetween. The end of the clamping arm 120B of the second embodiment presses on the same curved crevice 15 in the concha, as shown in FIG. 8 for the first embodiment.

FIG. 9 shows a modified third embodiment which is an earpiece device 100C in which the front clamping arm 120C, in this variation, starts from behind the ear, and curls around underneath the ear, and then curls around back towards the main body 130C to therebetween press on a slightly different part of the concha that is in the lower region of the ear, as shown in FIG. 9.

It is noted that, for the embodiments of FIGS. 4 and 9, for example, a user is able to lie with his or her side of the face on a pillow, even with the device 100A, 100C attached to the ear. Lying in this manner is not recommended, however, for the embodiment of FIG. 8 because, in so doing, the ear would compress the embodiment of the front clamping arm 120B that curves around the front of the ear in that particular second embodiment of FIG. 8.

### Different Electronic Devices

In the first embodiment of FIGS. 3 to 7, the earpiece-processor device 100A of FIG. 3 carries an electronic hearing-related device in the form of a sound processor 110A, however, in other modifications and embodiments, there is a wide range of possible electronic hearing-related device that are, or can be attached.

The attachment can be permanent, in the sense that the electronic hearing-related device forms part of the body of the device, whereas in other variations, the separable electronic hearing-related device is able to be attached by the user.

The invention in its broadest aspect is not limited to any one particular type of electronic hearing-related device, and can cover a wide range of devices that participate, in some manner, in the user's ability to hear. These can include any one or combination of: microphones, speakers, sound or speech processors, sound or signal transmitters, and the like etc.

The electronic hearing-related device can include a hearing-aid.

The electronic hearing-related device may include a sound wave receiver such as a microphone, and/or sound wave generator such as a small speaker.

The electronic hearing-related device may communicate one or two ways, for example, it can have a speaker that transmits sounds, or speech information to the user, and can also have a microphone for detecting the user's voice for transmission. In some embodiments, the electronic hearing-related device may therefore include a lightweight, short arm for supporting the microphone close to the user's mouth.

The electronic hearing-related device may receive and transmit electronic information in a wireless manner, making use of wireless transmitters, for example, those transmitters that are used in conjunction with mobile telephones to enable a small speaker to be positioned near the user's ear for hearing sounds that are received wirelessly via a mobile phone.

For example, the electronic hearing-related device may be able to communicate with a hearing-related implant within the user. For example, in the embodiment of FIGS. 3 and 4, the electronic hearing-related device includes a sound or speech processor 110A that is able to communicate with a hearing implant that has been surgically implanted into the user's head.

The electronic hearing-related device may be capable of emitting sounds that are hearable by the ear, such as a small speaker. For example, in a further modification, a small speaker can be embedded in the gripping portion 122A of the front clamping arm 120A, near its distal end 121A. In FIG. 6, the gripping portion 122A of the front clamping arm 120A is proximate the entrance to the ear canal when the device 100A is fitted on the ear, hence, such a small speaker could emit sounds that can be heard by the ear. In such variations, the shape of the gripping portion 122A can be modified so that the embedded microphone can be positioned as close as possible to the entrance of the ear canal, while maintaining the ability of the gripping portion 122A to grip part of the concha.

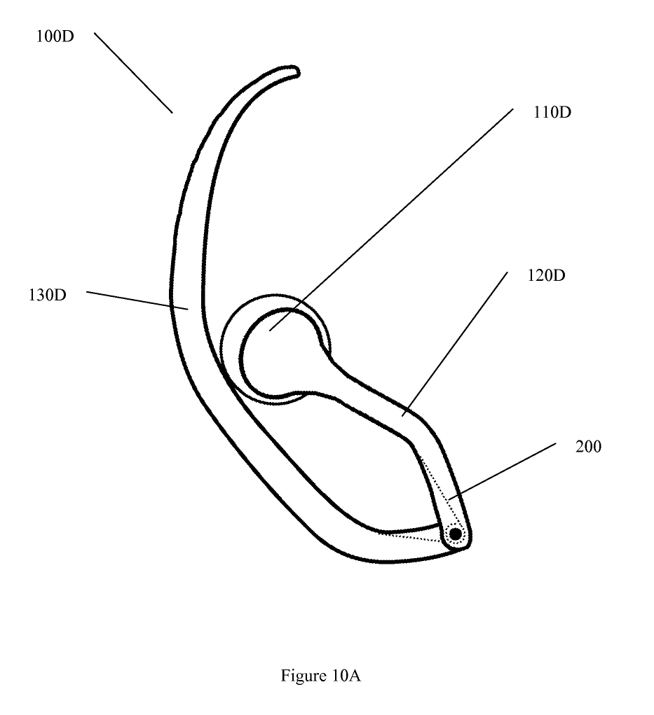

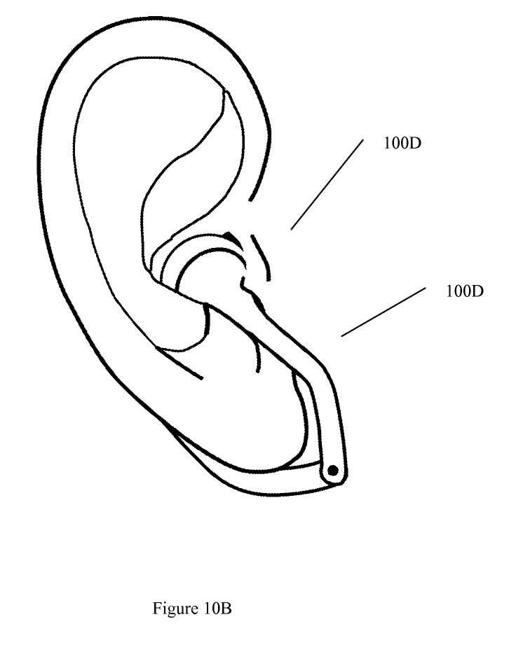

FIGS. 10A and 10B show a fourth embodiment that has a small ear-bud speaker 110D that is attached to the clamping mechanism 120D, 130D of the ear-piece device 100D. FIG. 10B shows how the ear-piece device 100D grips the concha from the front and rear of the ear. Resilient biasing of the clamping mechanism 120D, 130D is provided by the small spring 200 (shown in dotted lines) that is embedded with the components of the clamping mechanism 120D, 130D.

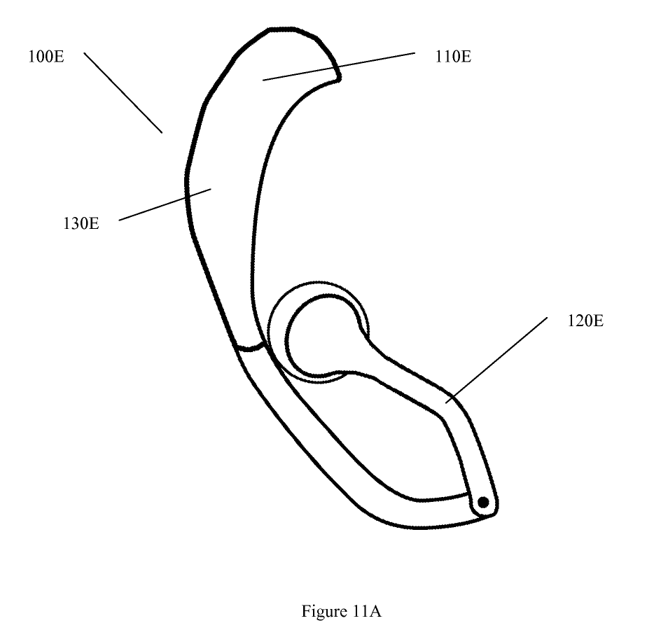

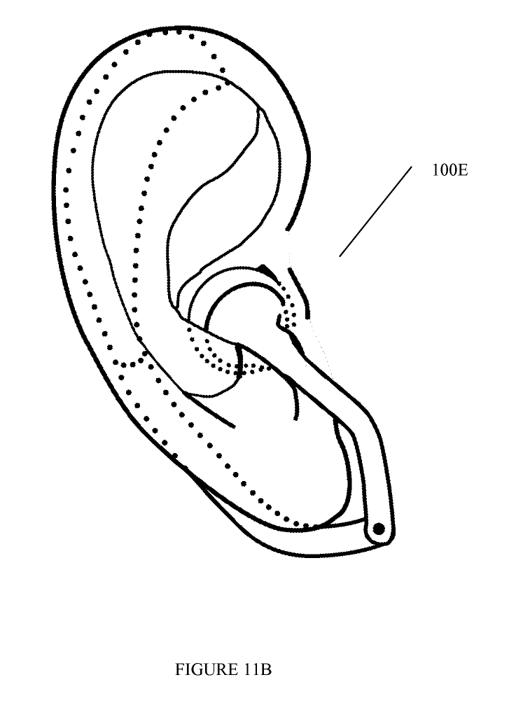

FIGS. 11A and 11B show a fifth embodiment in which the device 100E is provided with a small radio receiver 110E embedded in the main body 130E of the ear-piece device 100E. FIG. 11B shows how the ear-piece device 100E grips the concha from the front and rear of the ear. Resilient biasing of the clamping mechanism 120E, 130E is provided by the small spring 200 (not shown) that is embedded with the components of the clamping mechanism 120E, 130E.

In the embodiments, any such electronic circuitry, microprocessors and any batteries for the electronic hearing-related device can be located in the body of the ear-attachment device.

In the embodiments, the components of the ear-attachment devices can be made from any suitable material that does not interfere with the function of the electronic hearing-related device. For example, the components can be made of polymer material or materials, rubber, coated flexible metal or composites. In those embodiments where the components exhibit resilience, the selected material would have the required degree of resilience to achieve a clamping action. For example, the clamping components 120A, 130A of the first embodiment of FIGS. 3 and 4 are made of a resilient polymer material, such as Polyethylene or other suitable resilient polymer.

In other modifications, one or more surfaces of the clamping components can be provided with, or coated, to have some form of friction-enhancing surface. This is intended to increase the degree of friction between the components of the device 100 and the surface of the concha and other parts of the ear. The friction contributes to the ability of the embodiments to remain in place on the ear. The surface texture can also be provided to increase the comfort level felt by the user as a result of the surfaces of the device being in prolonged contact with the user's skin.

### Magnetic Embodiment

FIGS. 12A and 12B show a sixth embodiment in which the biasing-means, which urge the clamping components together, are provided with one or more magnetic components, such that the biasing is caused by, or enhanced by, the magnetic attractive force of the magnets.

In FIGS. 12A and 12B, one or more magnetic components are provided in each of the front clamping portion 120F and the rear body 130F. In use, the magnets in each of the front clamping portion 120F and the rear body 130F are mutually attractive to each other so as to bias the two parts 120F, 130F one towards the other.

In some variations, there can be a magnet in only one of the components, while the other component is made of a magnetically-attractive material, such as metal.

In the embodiment of FIGS. 12A and 12B, the microelectronics and components of the electronic hearing-related device are contained within the front clamping portion 120F. The circuitry of this embodiment may be provided with appropriate shielding to shield the circuitry from any detrimental effects of the magnetic field of the magnets, if required for proper operation of the particular electronic hearing-related device.

In embodiments, such as in FIGS. 12A and 12B, the front-concha-grip-means and the rear-concha-grip-means are both separate components.

The embodiments have been advanced by way of example only, and modifications are possible within the scope of the invention as defined by the appended claims.

In this specification, the notion of clamping the concha between parts of the earpiece simply refers to a situation where at least two parts of the earpiece device are urged together, with a part of the concha therebetween, in order to clamp the concha between the two parts.

In this specification, the words clamp, clamping, and other derivatives, are not to be limited to a nuance where two objects are pressed together by the clamping device, which is a nuance that is not used in this specification. Rather, the aim of the embodiment is to use the earpiece-processor device 100 to clamp the concha therebetween. Moreover, the concha is a single layer, not two layers, hence, the aforesaid nuance of the word clamp does not apply to the present invention in that sense.

In this specification, where the words comprise or comprises or derivatives thereof are used in relation to elements, integers, steps or features, this is to indicate that those elements, steps or features are present but it is not to be taken to preclude the possibility of other elements, integers, steps or features being present.

1. An ear-attachment device for attaching an electronic hearing-related device to an ear, comprising:
concha-gripping-means which is adapted to grip at least part of a concha of an ear therebetween, in use, and to which concha-gripping-means an electronic hearing-related device is attached or attachable.

2. An ear-attachment device of claim 1 wherein the concha-gripping-means includes:
front-concha-grip-means; and
rear-concha-grip-means,
wherein, in use, the concha-gripping-means is able to grip the concha therebetween with the front-concha-grip-means pressed against at least part of the front of the concha, and with the rear-concha-grip-means pressed against at least part of the other side of the ear that is behind the concha.

3. An ear-attachment device claim 1 wherein the front-concha-grip-means is adapted, in use, to apply pressure to the surface inside a curved crevice in the upper front portion of the concha.

4. An ear-attachment device of claim 1 wherein the concha-gripping-means has biasing-means that urges the front-concha-grip-means and the rear-concha-grip-means towards one another.

5. An ear-attachment device of claim 4 wherein the biasing-means is able to press both sides of the concha so as to hold the concha-gripping-means securely to the concha gripped therebetween.

6. An ear-attachment device of claim 4 wherein the biasing-means includes one or more magnetic components provided in each of the front-concha-grip-means and the rear-concha-grip-means which are mutually attractive to each other so as to bias one towards the other.

7. An ear-attachment device of claim 1 wherein the front-concha-grip-means and the rear-concha-grip-means are both separable components.

8. An ear-attachment device of claim 1 wherein the front-concha-grip-means and the rear-concha-grip-means comprise a single component.

9. An ear-attachment device of claim 1 wherein the front-concha-grip-means curls back towards the rear-concha-grip-means to form a clamping mechanism therebetween.

10. An ear-attachment device of claim 9 wherein the front-concha-grip-means, in use, wraps generally around the valley of the ear and curls back across the front of the ear towards the rear-concha-grip-means.

11. An ear-attachment device of claim 9 wherein the front-concha-grip-means, in use, curls around the lateral, front side of the ear and then curls around back towards the rear-concha-grip-means.

12. An ear-attachment device of claim 9 wherein the front-concha-grip-means, in use, curls underneath the ear and curls around back towards the rear-concha-grip-means.

13. An ear-attachment device of claim 1 wherein the electronic hearing-related device is capable of emitting sound hearable by the ear.

14. An ear-attachment device of claim 1 wherein the electronic hearing-related device includes a sound wave receiver and/or a sound wave generator.

15. An ear-attachment device of claim 1 wherein the electronic hearing-related device is able to communicate with a hearing-related implant in the user.

16. An ear-attachment device of claim 1 wherein the electronic hearing-related device includes a hearing-aid.

17. An ear-attachment device of claim 1 wherein the electronic hearing-related device includes an ear phone speaker.

18. A method of attaching an electronic hearing-related device to an ear, comprising the step of:
attaching an electronic hearing-related device to concha-gripping-means of an ear-attachment device; and
using the concha-gripping-means to grip therebetween at least part of a concha of an ear so as to secure the ear-attachment device to the ear.

19. A method of claim 18 wherein the concha-gripping-means includes:
front-concha-grip-means; and
rear-concha-grip-means,
and wherein the method includes the steps of:
pressing the front-concha-grip-means against at least part of the front of the concha; and
pressing the rear-concha-grip-means against at least part of the other side of the ear that is behind the concha such that the concha-gripping-means grips the concha therebetween.

20. A method of claim 19 wherein the concha-gripping-means has biasing-means that urges the front-concha-grip-means and the rear-concha-grip-means towards one another,
and wherein the biasing-means presses both sides of the concha so as to hold the concha-gripping-means securely to the concha gripped therebetween,
and wherein the biasing-means includes one or more magnetic components provided in each of the front-concha-grip-means and the rear-concha-grip-means which are mutually attractive to each other so as to bias one towards the other.
